(19) United States
(12) Patent Application Publication
(10) Pub. No.: US 2015/0171560 A1
(43) Pub. Date: Jun. 18, 2015

(54) ELECTRICAL CONNECTOR ASSEMBLY WITH IMPROVED METALLIC SHELL

(71) Applicant: ALLTOP ELECTRONICS (SUZHOU) LTD., Taicang City (CN)

(72) Inventors: Wang-I YU, Jhonghe City (TW); Hung-Chi TAI, Jhonghe City (TW); Yung-Chih HUNG, Jhonghe City (TW)

(73) Assignee: ALLTOP ELECTRONICS (SUZHOU) LTD., Taicang City (CN)

(21) Appl. No.: 14/208,117

(22) Filed: Mar. 13, 2014

(30) Foreign Application Priority Data
Dec. 12, 2013 (CN) 201310670895.5

(51) Int. Cl. H01R 13/659; H01R 13/717

(52) U.S. Cl. CPC H01R 13/659; H01R 13/7172

(57) ABSTRACT

An electrical connector assembly includes a number of stacked connectors and a metallic shell enclosing the stacked connectors. The metallic shell includes a first cage, a second cage and a third cage. The first cage includes a base portion and a pair of restricting portions bent downwardly from the base portion. Each restricting portion includes a number of recesses at its bottom edge and a number of press-fit legs located between the adjacent two recesses. The second cage includes a shielding plate and a number of locking arms bent upwardly from the shielding plate. Each locking arm includes a number of slits and a number of connecting portions each of which is located between the adjacent two slits. When the second cage is assembled to the first cage, the press-fit legs extend through the slits and the connecting portions are received in the recesses.

### BACKGROUND OF THE INVENTION

1. Field of the Invention

The present invention relates to an electrical connector assembly for being mounted to a circuit board, and more particularly to an electrical connector assembly with an improved metallic shell.

2. Description of Related Art

With rapid development of electronic technologies, electrical connectors have been widely used in electronic devices for exchanging information and data with external devices. A conventional connector usually includes an insulative housing, a plurality of contacts received in the insulative housing and a metallic shell enclosing the insulative housing. Each contact includes a soldering portion extending beyond the insulative housing for being soldered to a circuit board.

In order to meet the requirements of stable signal transmission and high effective transmission of the electronic devices, strong mating stabilization of the electrical connector needs to be ensured. However, a metallic shell of a conventional SFP connector usually includes two pieces of metallic cages mating with each other. In assembling, such two pieces of metallic cages may easily occur instability which will result in weak shielding effects. As a result, on one hand, the integral strength of the metallic shell is not good enough; on the other hand, when a mating plug is inserted into the SFP connector, normal signal transmission might be disturbed because of the poor shielding.

Hence, an electrical connector assembly with improved metallic shell is desired.

### BRIEF SUMMARY OF THE INVENTION

The present invention provides an electrical connector assembly including a plurality of stacked connectors and a metallic shell enclosing the stacked connectors. The stacked connectors include an insulative housing and a plurality of contact groups received in the insulative housing. The metallic shell includes a first cage, a second cage for mating with the first cage from a bottom side, and a third cage for mating with the first cage from a rear side. The first cage includes a base portion and a pair of restricting portions bent downwardly from opposite lateral sides of the base portion. Each restricting portion includes a plurality of recesses at its bottom edge and a plurality of press-fit legs each of which is located between the adjacent two recesses. The second cage includes a shielding plate and a plurality of locking arms bent upwardly from opposite lateral sides of the shielding plate. Each locking arm includes a plurality of slits and a plurality of connecting portions each of which is located between the adjacent two slits. When the second cage is assembled to the first cage, the press-fit legs extend through the slits and the connecting portions are received in the recesses.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of an electrical connector assembly in accordance with an illustrated embodiment of the present invention;

FIG. 2 is a partly exploded view of the electrical connector assembly as shown in FIG. 1;

FIG. 3 is a perspective view of a stacked connector as shown in FIG. 2;

FIG. 4 is an exploded view of the stacked connector as shown in FIG. 3;

FIG. 5 is a perspective view of an insulative housing as shown in FIG. 4;

FIG. 6 is another perspective view of the insulative housing as shown in FIG. 5;

FIG. 7 is an exploded view of a first contact group as shown in FIG. 4;

FIG. 8 is a perspective view of a first cage as shown in FIG. 2;

FIG. 9 is a perspective view of a second cage as shown in FIG. 2;

FIG. 10 is a perspective view of a third cage as shown in FIG. 2; and

FIG. 11 is a perspective view of a separating plate as shown in FIG. 2.

### DETAILED DESCRIPTION OF THE PREFERRED EMBODIMENT

Reference will now be made to the drawing figures to describe the embodiments of the present invention in detail. In the following description, the same drawing reference numerals are used for the same elements in different drawings.

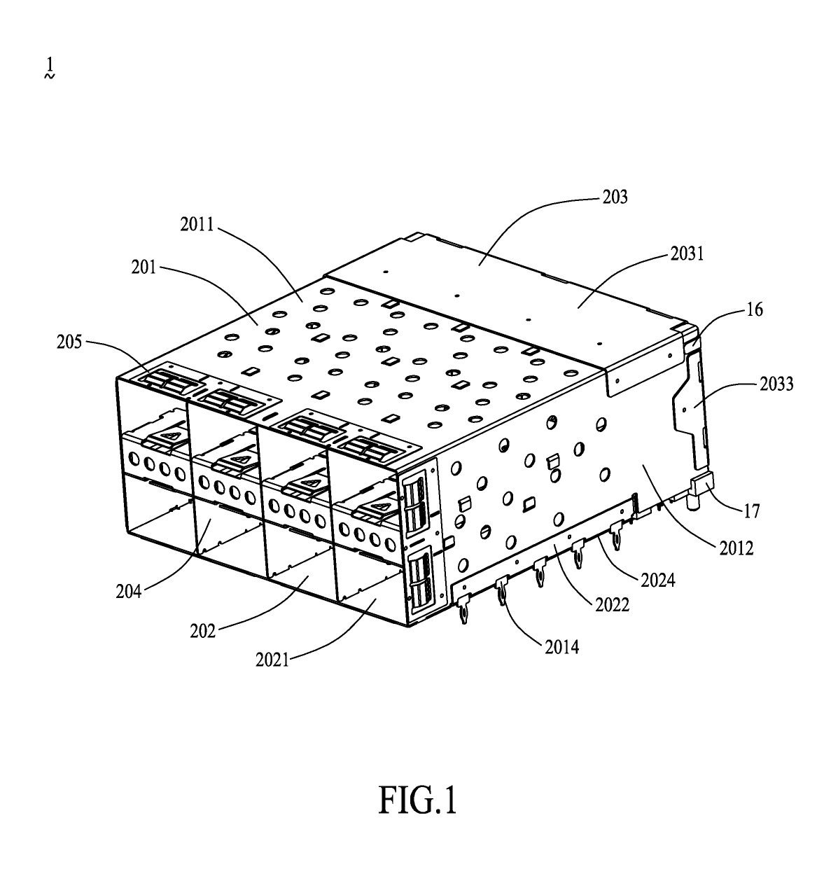

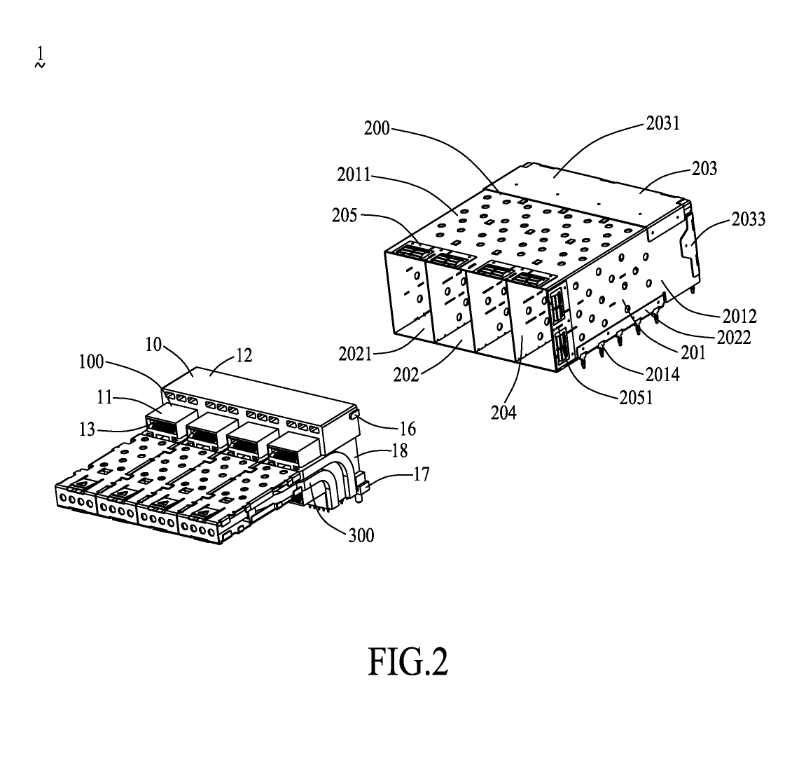

Referring to FIGS. 1 and 2, the present invention discloses an electrical connector assembly 1 for being mounted on a circuit board (not shown) for receiving a mating plug (not shown). The electrical connector assembly 1 includes a plurality of stacked connectors 100, a metallic shell 200 enclosing the stacked connectors 100 and a plurality of light pipes 300 between the stacked connectors 100 and the metallic shell 200.

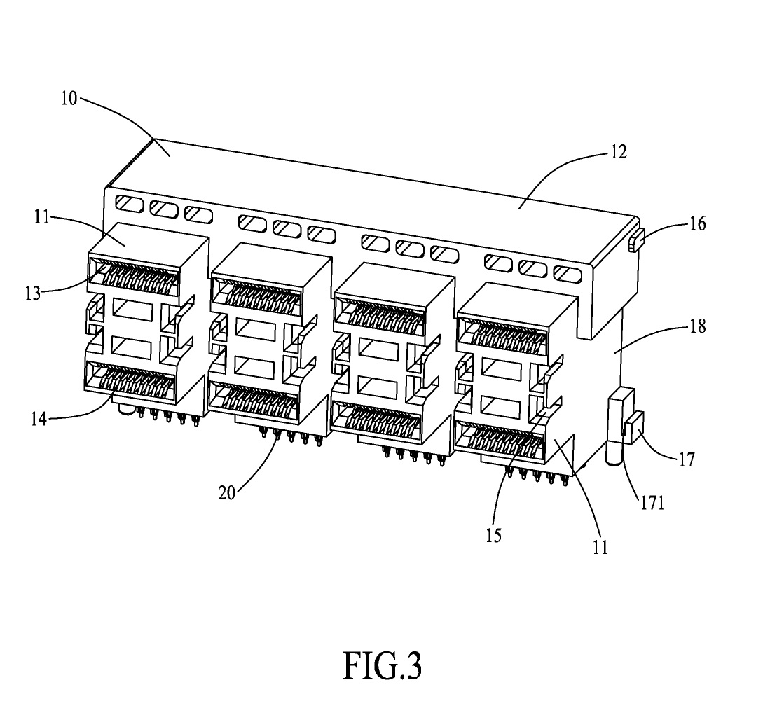

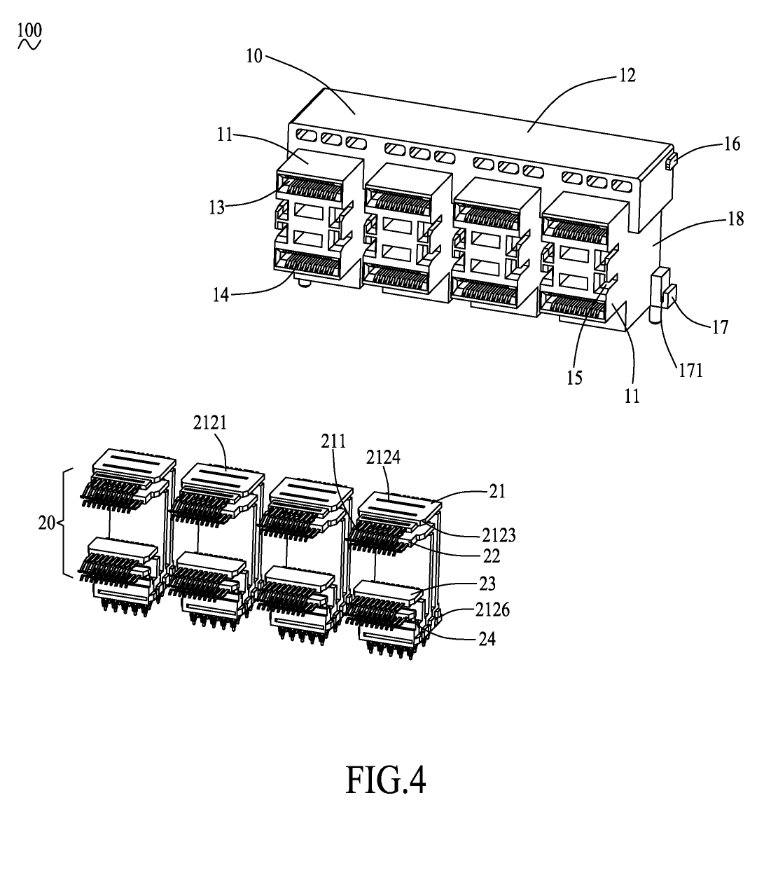

Referring to FIGS. 3 and 4, each stacked connector 100 includes an insulative housing 10 and a plurality contact groups 20 retained in the insulative housing 10. The contact groups 20 include a first contact group 21, a second contact group 22, a third contact group 23 and a fourth contact group 24 in turn along a top-to-bottom direction and a rear-to-front direction. The first, second, third and fourth contact groups 21, 22, 23 and 24 are of similar configurations, and the differences among them are that length and height of the first, second, third and fourth contact groups 21, 22, 23 and 24 are decreased in turn. The first, second, third and fourth contact groups 21, 22, 23 and 24 are separable with one another for easily replacement.

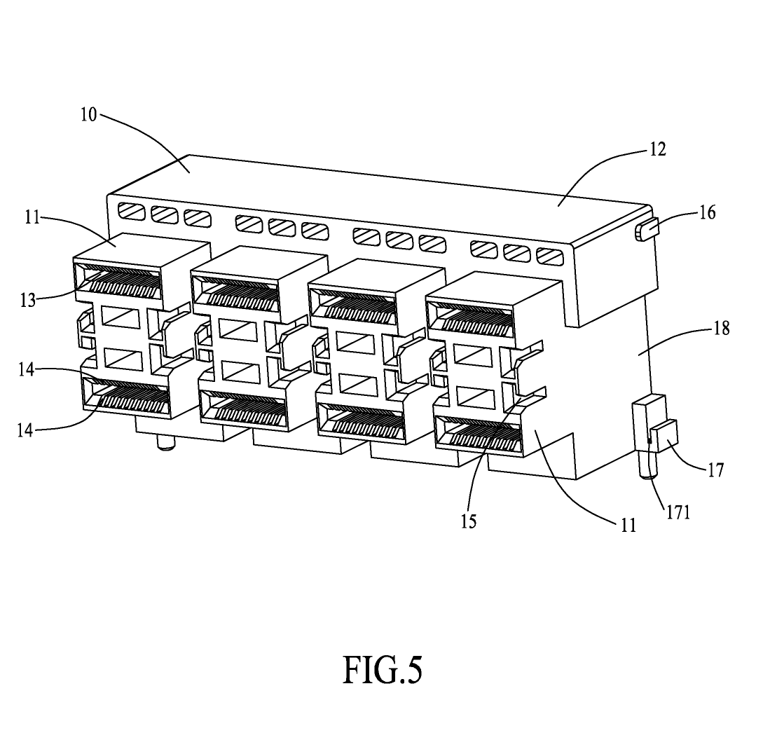

Referring to FIGS. 1 to 6, the insulative housing 10 includes a plurality of mating portions 11 and a plurality of receiving portions 12 extending rearwardly from the mating portions 11. Each mating portion 11 defines a mating slot 13 for receiving the mating plug and a plurality of passageways 14 extending rearwardly through the receiving portion 12 for mounting the contact groups 20. In accordance with the illustrated embodiment of the present invention, the passageways 14 include a plurality of upper passageways and lower passageways.

According to the illustrated embodiment of the present invention, the mating portions 11 along a height direction (a vertical direction) of the insulative housing 10 present two storeys and four lines. Referring to FIG. 3, the stacked connectors 100 can be regarded as connected side by side. Each stacked connector 100 includes a pair of slot 15 for assembling and fixing the light pipes 300. The first contact group 21 and the second contact group 22 are received in one of the mating portions 11 (i.e., an upper mating portion 11), and the third contact group 23 and the fourth contact group 24 are received in the other of the mating portions 11 (i.e., a lower mating portion 11). The first, second, third and fourth contact groups 21, 22, 23 and 24 extend beyond a bottom wall of the insulative housing 10 from the receiving portions 12. The upper passageways adapted for receiving the first contact group 21 are located between the lower passageways adapted for receiving the second contact group 22 along the vertical direction. Similarly, the upper passageways adapted for receiving the third contact group 23 are located between the lower passageways adapted for receiving the fourth contact group 24 along the vertical direction.

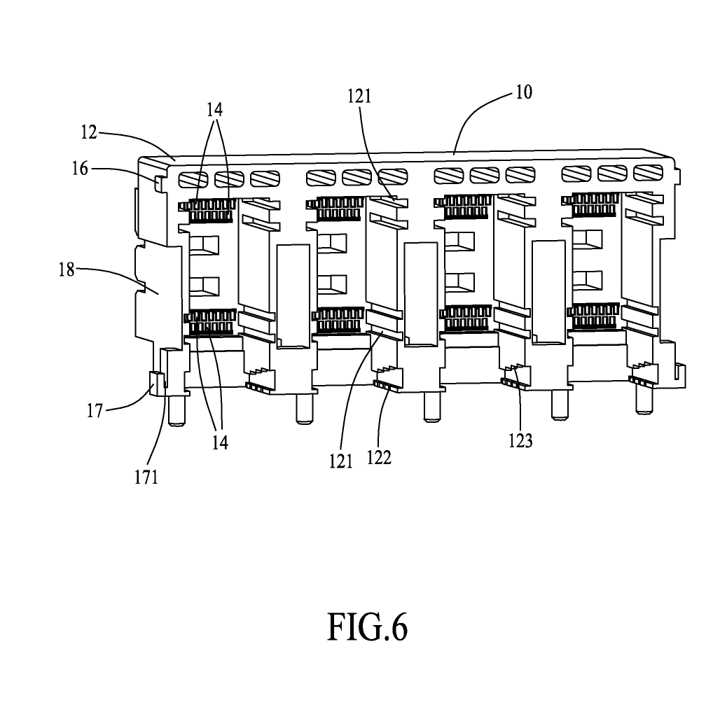

Referring to FIG. 6, each receiving portion 12 defines a plurality of guiding slots 121, a plurality of locking slots 122 at a bottom side thereof and a plurality of restricting slots 123 above the locking slots 122. The guiding slots 121, the restricting slots 123 and the locking slots 122 are arranged in turn along the vertical direction. Besides, the insulative housing 10 further includes a pair of first blocks 16 and a pair of second blocks 17 protruding outwardly from opposite sides of the receiving portion 12. The first blocks 16 are located at a top side of the receiving portion 12, while the second blocks 17 are located at a bottom side of the receiving portion 12. Each second block 17 defines a positioning slit 171. Furthermore, the insulative housing 10 includes a pair of fixing slots 18 on the opposite sides of the receiving portion 12 and located between the first blocks 16 and the second blocks 17.

Referring to FIGS. 2 to 7, the contact groups 20 are inserted into the mating portions 11 from the receiving portions 12 along the rear-to-front direction. Since the first, second, third and fourth contact groups 21, 22, 23 and 24 are of the similar configurations, only the first contact group 21 is selected for elaboration.

The first contact group 21 includes a plurality of first contacts 211 and at least one spacer 212 over-molding the first contacts 211. Each first contact 211 includes a contacting section 2111, an extending section 2112 extending rearwardly from the contacting section 2111, a bent section 2113 bent downwardly from the extending section 2112 and a press-fit leg 2114 extending from the bent section 2113. Each first contact 211 is of an L-shaped configuration taken from an integral view.

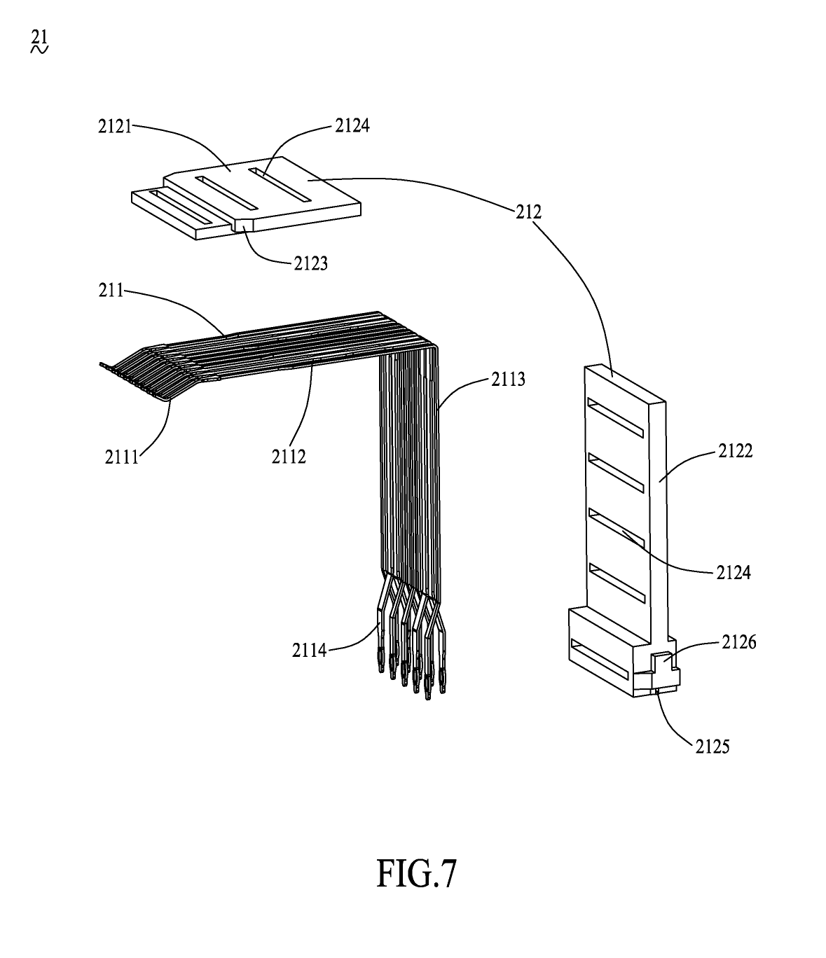

The contacting sections 2111 are curved and elastic. When the contacting sections 2111 are received in the passageways 14, they partly extend into the mating slot 13 for easily mating with the mating plug. The press-fit legs 2114 are of V-shaped or Z-shaped configurations. As shown in FIG. 7, the press-fit legs 2114 of adjacent contacts of the same contact group are bent along opposite directions so that the press-fit legs 2114 can be regulated in two rows. Such two-row arrangement of the press-fit legs 2114 is easily for being mounted to the circuit board, especially when the press-fit legs 2114 are of high density. Referring to FIGS. 4 and 7, the contacting sections 2111 of the first, second, third and fourth contact groups 21, 22, 23 and 24 are arranged in turn along a top-to-bottom direction in four storeys, and the press-fit legs 2114 of the first, second, third and fourth contact groups 21, 22, 23 and 24 are arranged in turn a rear-to-front direction in eight rows.

The contacting sections 2111 of the first contact group 21 and the second contact group 22 are bent along opposite directions and are arranged in a face-to-face manner. The contacting sections 2111 of the first contact group 21 are located between the contacting sections 2111 of the second contact group 22 along the vertical direction. Similarly, the contacting sections 2111 of the third contact group 23 and the fourth contact group 24 are bent along opposite directions and are arranged in a face-to-face manner as well. The contacting sections 2111 of the third contact group 23 are located between the contacting sections 2111 of the fourth contact group 24 along the vertical direction.

The spacer 212 includes a first spacer 2121 over-molding the extending sections 2112 and a second spacer 2122 over-molding the bent sections 2113 and/or the press-fit legs 2114. The first spacer 2121 includes a pair of opposite inclined surfaces 2123 for easily guiding insertion of the first spacer 2121 into the insulative housing 10. According to the illustrated embodiment of the present invention, both the first spacer 2121 and the second spacer 2122 define a plurality of heat-dissipating slots 2124 so that heat generated by each contact group can be dissipated to the air through such heat-dissipating slots 2124.

When the first contact group 21 is assembled to the insulative housing 10, under the guidance of the inclined surfaces 2123, lateral sides of the first spacer 2121 is received in the guiding slot 121. Besides, the second spacer 2122 is perpendicular to the first spacer 2121. The second spacer 2122 includes a pair of locking blocks 2125 secured in the locking slots 122 and a pair of restricting blocks 2126 connected above corresponding locking blocks 2125 for being received in the restricting slots 123. As a result, the first contact group 21 can be prevented from withdrawing from the insulative housing 10.

Referring to FIG. 2, the metallic shell 200 includes an essentially reverse U-shaped first cage 201, a second cage 202 for mating with the first cage 201 from a bottom side, and a third cage 203 for mating with the first cage 201 from a rear side.

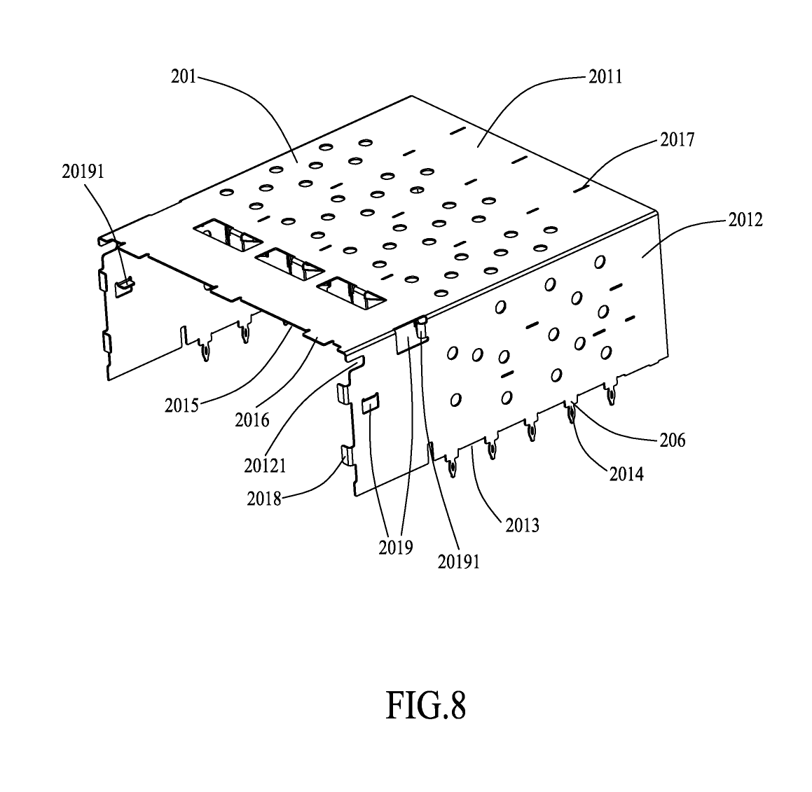

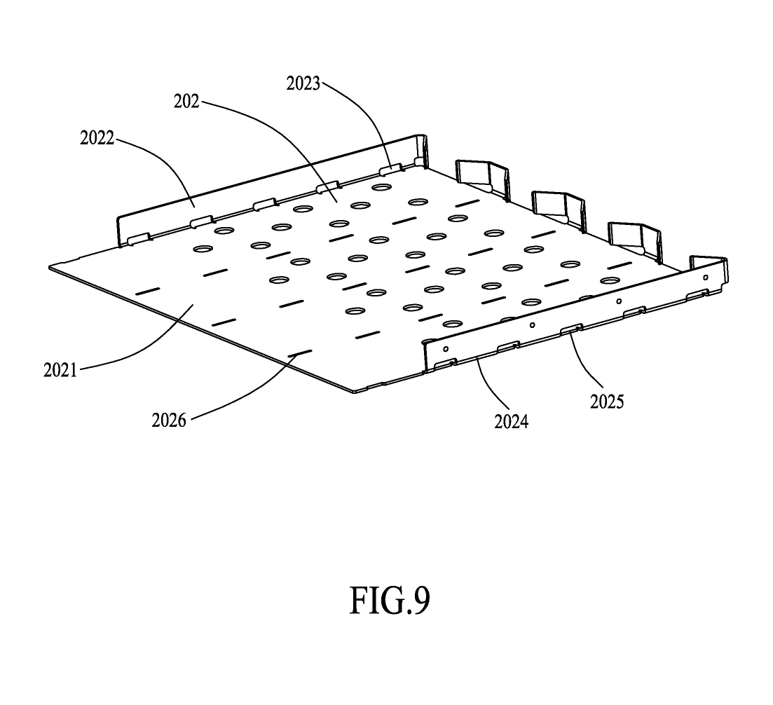

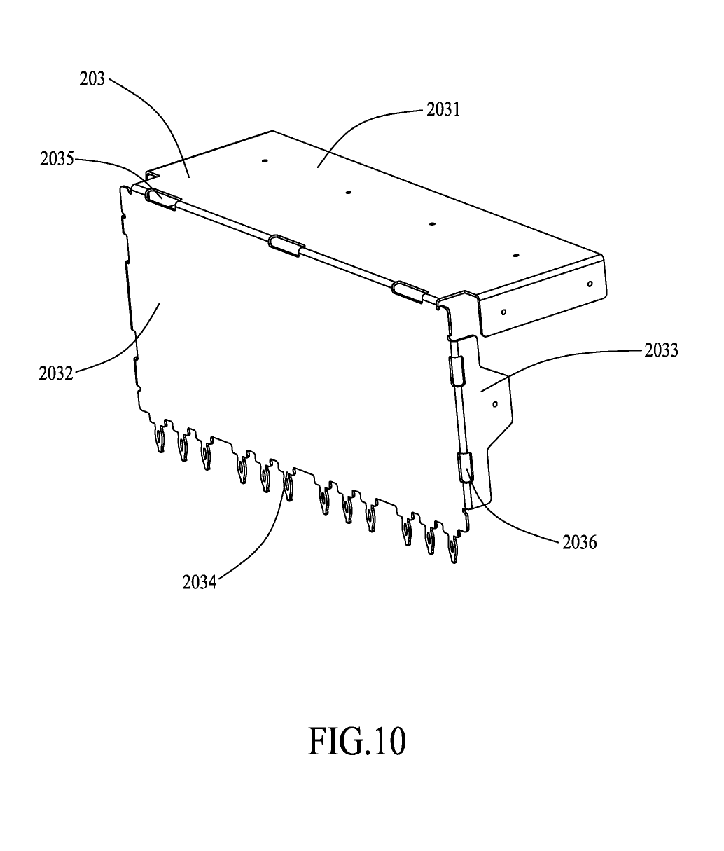

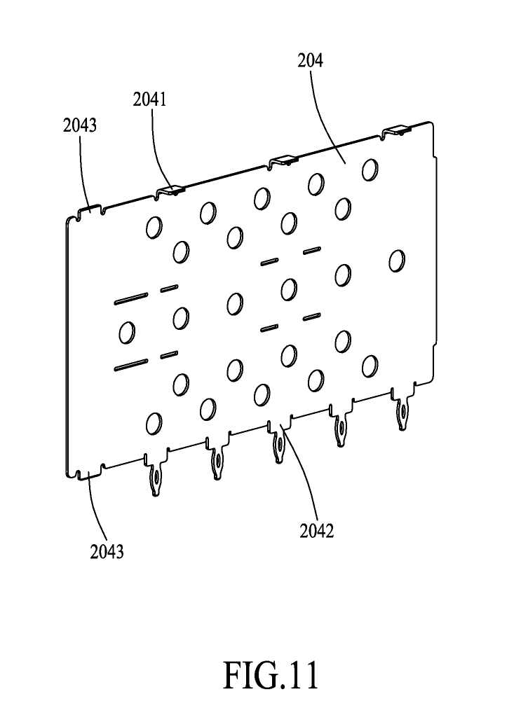

Referring to FIGS. 8 to 11, the first cage 201 includes a base portion 2011 and a pair of restricting portions 2012 bent downwardly from opposite lateral sides of the base portion 2011. Each restricting portion 2012 defines a plurality of recesses 2013 at its bottom edge, a plurality of protrusions 206 each formed between the adjacent two recesses 2013, and a plurality of hollow press-fit legs 2014 extending downwardly from corresponding protrusions 206. Besides, the base portion 2011 includes a plurality of cutouts 2015 at the rear side thereby forming a plurality of tabs 2016 each of which is formed between the adjacent two cutouts 2015. The base portion 2011 further includes a plurality of first slits 2017 opposite to the tabs 2016.

Each restricting portion 2012 includes a plurality of bent protrusions 2018 at the rear side thereof. Each restricting portion 2012 includes a rear cutout 20121 for receiving the first block 16. Besides, the bottom edges of the restricting portions 2012 is inserted into the positioning slits 171 of the second blocks 17. As a result, the first cage 201 can be stably fixed to the insulative housing 10.

Each restricting portion 2012 includes a plurality of openings 2019 and two restricting pieces 20191 protruding inwardly towards the first cage 201. One of the restricting pieces 20191 is adapted for abutting against a front side of the receiving portion 12, and the other of the restricting pieces 20191 is adapted for abutting against a top side of the fixing slot 18. As a result, the first cage 201 can be stably fixed to the insulative housing 10.

The second cage 202 includes a shielding plate 2021 and a plurality of locking arms 2022 bent upwardly from opposite lateral sides of the shielding plate 2021. Each locking arm 2022 includes a plurality of slits 2023 and a plurality of connecting portions 2024 each of which is located between the adjacent two slits 2023. Each shielding plate 2021 includes a plurality of engaging portions 2025 each of which extends towards corresponding slit 2023. When the press-fit legs 2014 extend through the slits 2023, the locking arms 2022 are located outside of corresponding restricting portions 2012 so that the corresponding restricting portions 2012 are limited along an inside-to-outside direction, while the engaging portions 2025 are located inside of the protrusions 206 so that the corresponding restricting portions 2012 are limited along an outside-to-inside direction. As a result, the integral strength of the first cage 201 and the second cage 202 is improved and signal transmission can be protected because of the excellent shielding effect. Besides, the shielding plate 2021 includes a plurality of second slits 2026.

Referring to FIGS. 1, 2 and 10, the third cage 203 includes a first shielding portion 2031 covering the base portion 2011 of the first cage 201, a second shielding portion 2032 bent downwardly from the first shielding portion 2031 to cover the insulative housing 10, and a pair of third shielding portions 2033 bent forwardly from lateral edges of the second shielding portion 2032. The pair of third shielding portions 2033 are lockable to the pair of restricting portions 2012 of the first cage 201. The second shielding portion 2032 is perpendicular to the first shielding portion 2031 and the third shielding portions 2033. The second shielding portion 2032 includes a plurality of press-fit legs 2034 for being mounted to the circuit board.

A joint of the first shielding portion 2031 and the second shielding portion 2032 defines a plurality of through holes 2035 through which the tabs 2016 are inserted. Joints of the third shielding portions 2033 and the second shielding portion 2032 define a plurality of through holes 2036 to lock with the bent protrusions 2018. According to the illustrated embodiment of the present invention, the through holes 2035, 2036 are of rectangular configurations, the first cage 201 and the third cage 203 can be well assembled with the tabs 2016 and the bent protrusions 2018 respectively locking in the through holes 2035, 2036. Simultaneously, the shielding effect of the first cage 201 and the third cage 203 can be ensured.

The metallic shell 200 includes a plurality of separating plates 204 between the first cage 201 and the second cage 202. Each separating plate 204 includes a plurality of L-shaped locking tabs 2041 fixed to the base portion 2011 of the first cage 201 and a plurality of press-fit portions 2042 extending downwardly through the shielding plate 2021 of the second cage 202. The locking tabs 2041 extend through the first slits 2017, and the press-fit portions 2042 extend through the second slits 2026 for supporting the first cage 201 and the second cage 202. Besides, each separating plate 204 further includes a pair of upward and downward protuberances 2043 on top and bottom side thereof.

The metallic shell 200 includes a plurality of grounding pieces 205 surrounding around the first cage 201 and the second cage 202. At least one of the grounding pieces 205 defines a through opening 2051 to receive the upward protuberance 2043. According to the illustrated embodiment of the present invention, the grounding pieces 205 are soldered to the first cage 201 and the second cage 202 via spot welding. The third cage 203 is fixed to the first cage 201 via spot welding. The second cage 202 is fixed to the first cage 201 via spot welding as well.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. An electrical connector assembly comprising:
a plurality of stacked connectors comprising an insulative housing and a plurality of contact groups received in the insulative housing;
a metallic shell enclosing the stacked connectors, the metallic shell comprising a first cage, a second cage for mating with the first cage from a bottom side, and a third cage for mating with the first cage from a rear side, the first cage comprising a base portion and a pair of restricting portions bent downwardly from opposite lateral sides of the base portion, each restricting portion comprising a plurality of recesses at its bottom edge and a plurality of press-fit legs each of which is located between the adjacent two recesses; the second cage comprising a shielding plate and a plurality of locking arms bent upwardly from opposite lateral sides of the shielding plate, each locking arm comprising a plurality of slits and a plurality of connecting portions each of which is located between the adjacent two slits; wherein
when the second cage is assembled to the first cage, the press-fit legs extend through the slits and the connecting portions are received in the recesses.

2. The electrical connector assembly as claimed in claim 1, wherein each restricting portion comprises a plurality protrusions each of which is located between the adjacent two recesses, and the press-fit legs extend downwardly from corresponding protrusions.

3. The electrical connector assembly as claimed in claim 2, wherein the shielding plate comprises a plurality of engaging portions each of which extends towards corresponding slit; and wherein
when the press-fit legs extend through the slits, the locking arms are located outside of corresponding restricting portions so that the corresponding restricting portions are limited along an inside-to-outside direction, while the engaging portions are located inside of the protrusions so that the corresponding restricting portions are limited along an outside-to-inside direction.

4. The electrical connector assembly as claimed in claim 1, wherein the third cage comprises a first shielding portion covering the base portion of the first cage, a second shielding portion bent downwardly from the first shielding portion to cover the insulative housing, and a pair of third shielding portions bent forwardly from lateral edges of the second shielding portion, the pair of third shielding portions being lockable to the pair of restricting portions of the first cage.

5. The electrical connector assembly as claimed in claim 4, wherein the second shielding portion is perpendicular to the first shielding portion and the third shielding portions.

6. The electrical connector assembly as claimed in claim 4, wherein the base portion of the first cage comprises a plurality of cutouts at the rear side thereby forming a plurality of tabs each of which is formed between the adjacent two cutouts, and a joint of the first shielding portion and the second shielding portion defines a plurality of through holes through which the tabs are inserted.

7. The electrical connector assembly as claimed in claim 4, wherein the restricting portions comprise a plurality of bent protrusions at the rear side, and joints of the third shielding portions and the second shielding portion define a plurality of through holes to lock with the bent protrusions.

8. The electrical connector assembly as claimed in claim 1, wherein the metallic shell comprises a plurality of separating plates between the first cage and the second cage, each separating plate comprising a plurality of L-shaped locking tabs fixed to the base portion of the first cage and a plurality of press-fit portions extending downwardly through the shielding plate of the second cage.

9. The electrical connector assembly as claimed in claim 8, wherein the base portion of the first cage comprises a plurality of first slits through which the locking tabs extend, and the shielding plate of the second cage comprises a plurality of second slits through which the press-fit portions extend.

10. The electrical connector assembly as claimed in claim 8, wherein the metallic shell comprises a plurality of grounding pieces surrounding around the first cage and the second cage, at least one of the separating plate comprises an upward protuberance and at least one of the grounding pieces defines a through opening to receive the upward protuberance.

11. The electrical connector assembly as claimed in claim 10, wherein the grounding pieces are soldered to the first cage and the second cage via spot welding, the third cage is fixed to the first cage via spot welding, and the second cage is fixed to the first cage via spot welding as well.

12. An electrical connector assembly comprising:
a plurality of stacked connectors comprising an insulative housing, a plurality of contact groups received in the insulative housing and a plurality of light pipes at opposite sides of each stacked connector;
a metallic shell enclosing the stacked connectors, the metallic shell comprising a first cage and a second cage for mating with the first cage from a bottom side, the first cage comprising a base portion and a pair of restricting portions bent downwardly from opposite lateral sides of the base portion, each restricting portion comprising a plurality of recesses at its bottom edge and a plurality of press-fit legs each of which is located between the adjacent two recesses; the second cage comprising a shielding plate, a plurality of locking arms bent upwardly from opposite lateral sides of the shielding plate, a plurality of slits formed at boundaries of the shielding plate and the locking arms, and a plurality of connecting portions each of which is located between the adjacent two slits; wherein
when the second cage is assembled to the first cage, the press-fit legs extend through the slits and the connecting portions are received in the recesses.

13. The electrical connector assembly as claimed in claim 12, wherein each restricting portion comprises a plurality protrusions each of which is located between the adjacent two recesses, and the press-fit legs extend downwardly from corresponding protrusions.

14. The electrical connector assembly as claimed in claim 13, wherein the shielding plate comprises a plurality of engaging portions each of which extends towards corresponding slit; and wherein
when the press-fit legs extend through the slits, the locking arms are located outside of corresponding restricting portions so that the corresponding restricting portions are limited along an inside-to-outside direction, while the engaging portions are located inside of the protrusions so that the corresponding restricting portions are limited along an outside-to-inside direction.

15. The electrical connector assembly as claimed in claim 12, wherein the metallic shell comprises a third cage for mating with the first cage from a rear side, the third cage comprising a first shielding portion covering the base portion of the first cage, a second shielding portion bent downwardly from the first shielding portion to cover the insulative housing, and a pair of third shielding portions bent forwardly from lateral edges of the second shielding portion, the pair of third shielding portions being lockable to the pair of restricting portions of the first cage.

16. The electrical connector assembly as claimed in claim 15, wherein the second shielding portion is perpendicular to the first shielding portion and the third shielding portions.

17. The electrical connector assembly as claimed in claim 15, wherein the base portion of the first cage comprises a plurality of cutouts at the rear side thereby forming a plurality of tabs each of which is formed between the adjacent two cutouts, and a joint of the first shielding portion and the second shielding portion defines a plurality of through holes through which the tabs are inserted.

18. The electrical connector assembly as claimed in claim 15, wherein the restricting portions comprise a plurality of bent protrusions at the rear side, and joints of the third shielding portions and the second shielding portion define a plurality of through holes to lock with the bent protrusions.

19. The electrical connector assembly as claimed in claim 12, wherein the metallic shell comprises a plurality of separating plates between the first cage and the second cage, each separating plate comprising a plurality of L-shaped locking tabs fixed to the base portion of the first cage and a plurality of press-fit portions extending downwardly through the shielding plate of the second cage.

20. The electrical connector assembly as claimed in claim 19, wherein the metallic shell comprises a plurality of grounding pieces surrounding around the first cage and the second cage, at least one of the separating plates comprises an upward protuberance and at least one of the grounding pieces defines a through opening to receive the upward protuberance.
